(19) United States
(12) Patent Application Publication
(10) Pub. No.: US 2020/0279194 A1
(43) Pub. Date: Sep. 3, 2020

(54) SYSTEMS AND METHODS FOR UNCERTAINTY-AWARE MATCHING OF TRANSPORTATION REQUESTORS AND PROVIDERS

(71) Applicant: Lyft, Inc., San Francisco, CA (US)

(72) Inventors: Matthew James Piccolella, San Francisco, CA (US); James Kevin Murphy, San Francisco, CA (US); Serdar Colak, San Francisco, CA (US); Danial Afzal, Rio Grande, PR (US)

(21) Appl. No.: 16/290,796

(22) Filed: Mar. 1, 2019

(51) Int. Cl. G06Q 10/02; G06Q 50/30; G01C 21/36

(52) U.S. Cl. CPC G06Q 10/02; G01C 21/367; G06Q 50/30

(57) ABSTRACT

The disclosed computer-implemented method may include providing and making use of uncertain ETA information. Inaccurate ETA information may result in ride cancellations, poor experience on the part of transportation requestors and providers, and reduced transportation network efficiency. Errors in ETA estimates may be introduced in various ways, including inaccurate starting location data for providers, variable delays in provider navigation readiness, providers failing to react in time to take expected routes to newly assigned destinations, and driving conditions en route. By estimating both the likelihood various scenarios that impact ETA and the impact of these scenarios on arrival time, the method may provide information about the uncertainty of ETA information. Various other methods, systems, and computer-readable media are also disclosed.

### BACKGROUND

A dynamic transportation matching service may match individuals and groups who request transportation from a starting point to a destination with transportation providers, such as cars, that are associated with a dynamic transportation network managed by the dynamic transportation matching system. In some cases, the dynamic transportation matching system may provide transportation requestors with an estimated time of arrival (ETA) of a transportation provider. Transportation requestors may rely on these ETAs to make plans and may cancel transportation requests when the ETA turns out to be inaccurate. For example, an ETA of fifteen minutes may inspire a transportation requestor to get a few quick things done around the house while waiting for the provider. If the provider shows up in two minutes, the requestor may not yet be ready to leave and may instead cancel the ride. Conversely, if a requestor receives an ETA of two and ten minutes pass without a provider appearing, the requestor may become frustrated and cancel. In either case, the requestor has had a poor experience with the dynamic transportation matching system due to the inaccurate ETA.

Unfortunately, it may be difficult to pinpoint a provider ETA given all of the many factors that can introduce uncertainty as to when exactly the provider will arrive. Accordingly, the instant disclosure identifies and addresses a need for additional and improved systems and methods for uncertainty-aware matching of transportation requestors and providers.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of an example scenario involving a transportation requestor and multiple possible transportation providers.

FIG. 2 is an illustration of an example architecture for matching requestors and providers based at least in part on uncertainty information.

FIG. 3 is an illustration of an example scenario involving a transportation requestor and a transportation provider.

FIG. 4 is an illustration of an example scenario involving a transportation requestor and a transportation provider.

FIG. 5 is an illustration of a set of probability graphs for two transportation providers.

FIG. 6 is a flow diagram of an example probability tree.

FIG. 7 is an illustration of a set of probability graphs for one transportation provider.

FIG. 8 is an illustration of an example scenario where several transportation requestors share a transportation provider.

FIG. 9 is an illustration of an example requestor device displaying ETA uncertainty information.

FIG. 10 is an illustration of an example requestor device displaying ETA uncertainty information.

FIG. 11 is an illustration of an example requestor device displaying ETA uncertainty information and estimated time to destination information.

FIG. 12 is a block diagram of an example system for uncertainty-aware matching of transportation requestors and providers.

FIG. 13 is a flow diagram of an example method for uncertainty-aware matching of transportation requestors and providers.

FIG. 14 is an illustration of an example requestor/provider management environment.

FIG. 15 is an illustration of an example data collection and application management system.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to systems and methods for providing and making use of uncertain ETA information when matching transportation providers and requestors. Inaccurate ETA information can result in ride cancellations, poor experience on the part of transportation requestors and providers, and reduced transportation network efficiency. Errors in ETA estimates may be introduced in various ways, including inaccurate starting location data for providers, variable delays in provider navigation readiness, providers failing to react in time to take expected routes to newly assigned destinations, and driving conditions en route. By estimating both the likelihood various scenarios that impact ETA and the impact of these scenarios on arrival time, the method may provide information about the uncertainty of ETA information. For example, the method may provide an ETA probability distribution. ETA uncertainty information (such as an ETA probability distribution) may then be used to make decisions within the transportation network (e.g., matching decisions). For example, the method may match a transportation requestor to a transportation provider with a higher ETA over a transportation provider with greater ETA uncertainty. In some cases, the method may delay a matching decision until ETA uncertainty decreases. In this example, the method may provide information regarding how quickly the uncertainty of ETA information is expected to resolve (e.g., how long until it is known whether a transportation provider was able to react in time to make a needed turn at an intersection). By reducing the uncertainty of ETAs provided to requestors and/or providing requestors with information about ETA uncertainty (e.g., an ETA range), the systems described herein may improve user experience, reduce cancellations, and/or improve the efficiency of a dynamic transportation network. Accordingly, as may be appreciated, the systems and methods described herein may improve the functioning of a computer that matches transportation requestors and providers by reducing the cancellations that detract from the efficiency of the matching algorithm. Furthermore, for the reasons mentioned above and to be discussed in greater detail below, the systems and methods described herein may provide advantages to the field of dynamic transportation by improving user experience and/or transportation network efficiency.

As will be explained in greater detail below, a dynamic transportation matching system may arrange transportation on an on-demand and/or ad-hoc basis by, e.g., matching one or more transportation requestors and/or transportation requestor devices with one or more transportation providers and/or transportation provider devices. For example, a dynamic transportation matching system may match a transportation requestor to a transportation provider that operates within a dynamic transportation network (e.g., that is managed by, coordinated by, and/or drawn from by the dynamic transportation matching system to provide transportation to transportation requestors).

In some examples, available sources of transportation within a dynamic transportation network may include vehicles that are owned by an owner and/or operator of the dynamic transportation matching system. Additionally or alternatively, sources of transportation within a dynamic transportation network may include vehicles that are owned outside of the dynamic transportation network but that participate within the dynamic transportation network by agreement. In some examples, the dynamic transportation network may include road-going vehicles (e.g., cars, light trucks, etc.). Furthermore, the dynamic transportation network may include personal mobility vehicles. In some embodiments, a dynamic transportation network may include autonomous vehicles (e.g., self-driving cars) that may be capable of operating with little or no input from a human operator.

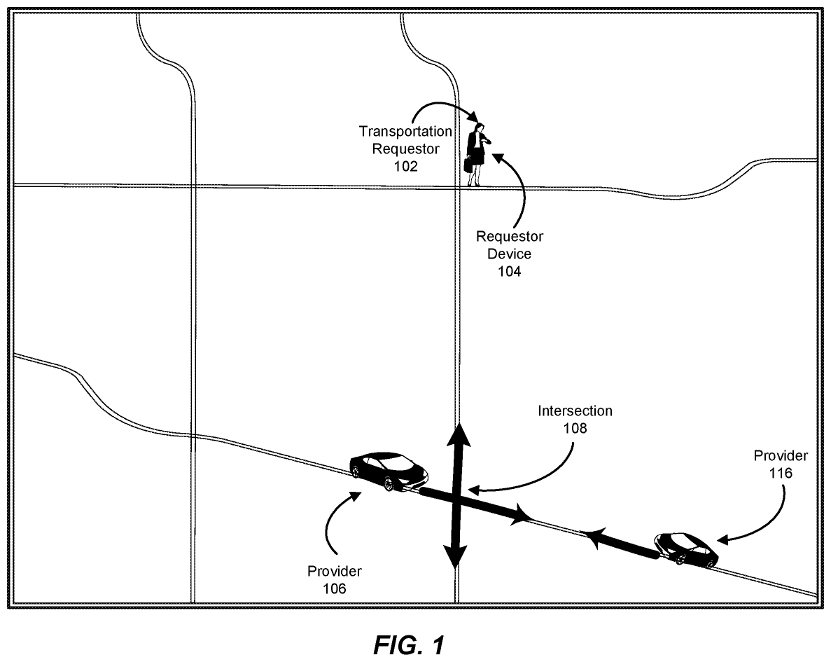

FIG. 1 illustrates an example scenario involving a transportation requestor and multiple possible transportation providers. In some examples, a transportation requestor 102 may request transportation via a requestor device 104. In one example, a provider 106 may be closer to transportation requestor 102 than a provider 116. In some examples, a naïve matching algorithm may match provider 106 with transportation requestor 102 due to provider 106 being the closest available provider (e.g., in terms of travel distance, absolute distance, and/or naïvely estimated ETA). However, provider 106 may continue straight or turn right, necessitating a U-turn to meet transportation requestor 102 and rendering any initial ETA provided to transportation requestor 102 inaccurate due to the added delay. Because of the uncertainty associated with the proximity of provider 106 to intersection 108, it may be more efficient to match provider 116 with transportation requestor 102. In some examples, there may be less uncertainty associated with an ETA for provider 116 because provider 116 may be far enough from intersection 108 (or any other intersection) that the likelihood of provider 116 failing to make the correct turn (i.e., to meet transportation requestor 102) is low.

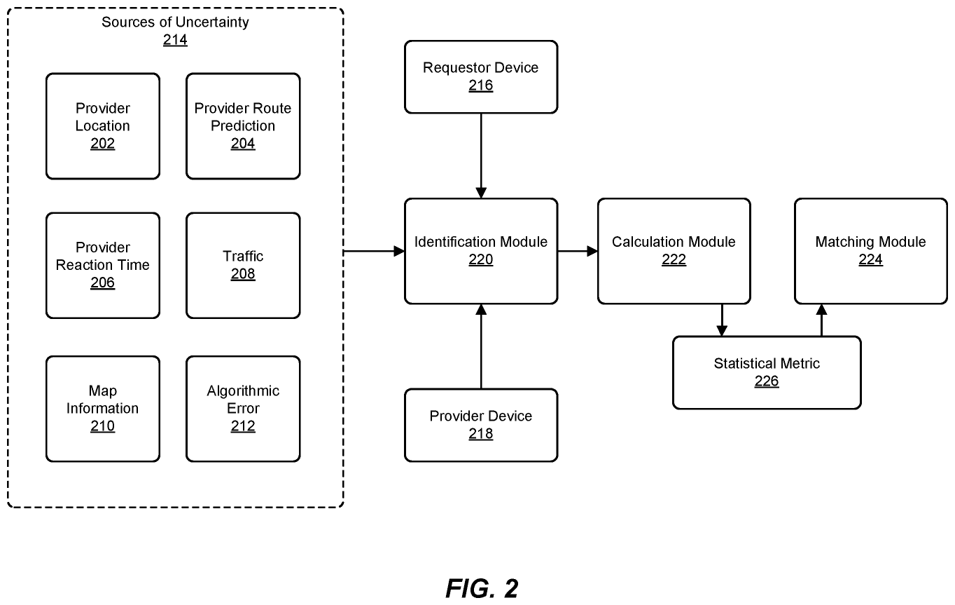

FIG. 2 illustrates an example architecture for matching requestors and providers based at least in part on uncertainty information. In one embodiment, an identification module 220 may identify a set of sources of uncertainty 214 in the ETA of a provider device 218 meeting a transportation requestor associated with a requestor device 216. In some examples, sources of uncertainty 214 may include provider location 202, provider route prediction 204, provider reaction time 206, traffic 208, map information 210, and/or algorithmic error 212. In some examples, provider location 202 may represent uncertainty about the location of a provider due to potentially inaccurate location system data, stale location data (e.g., older than a certain threshold, such as thirty seconds, one minute, or five minutes, and therefore indicating a decreased likeliness that the location data represents the actual current location), and/or inaccurate mapping data for the provider's current location (e.g., provider is on a street not listed in the mapping data). In some examples, provider route prediction 204 may represent uncertainty about the near-future location of the provider due to potentially inaccurate bearing information (e.g., information about the current direction of travel of the provider), potentially inaccurate speed information, uncertain prediction of near-future choices (e.g., turns at intersections), and/or uncertain prediction about requestor behavior (e.g., how long will it take the provider to pick up an already-matched requestor for a shared ride). Provider reaction time 206 may represent uncertainty about how long it will take the provider to receive information about the new match (e.g., on a provider device), accept the new match, receive directions to the new match, and/or respond to directions to meet the new requestor. In some examples, provider reaction time 206 may also represent uncertainty about the exact location of the provider. For example, if the provider is in a left-turn-only lane of an intersection rather than the right-hand lane, the provider may not be able to react to directions to turn right at the intersection even if the provider receives the directions before entering the intersection. In some examples, traffic 208 may represent uncertainty caused by unpredictably changing traffic conditions (e.g., an accident) and/or inaccurate information about current traffic. In one example, traffic 208 may also represent uncertainty introduced by traffic lights with long cycles. In some examples, map information 210 may represent uncertainty introduced by potentially inaccurate map data between the provider and the requestor (e.g., missing streets and/or inaccurate information on the legality of turns). In some examples, algorithmic error 212 may represent uncertainty introduced by imperfections in the algorithm used to calculate estimated arrival time. In some embodiments, identification module 220 may identify other relevant sources of uncertainty beyond those described above.

In one embodiment, a calculation module 222 may calculate a statistical metric 226 that reflects the overall uncertainty from the various sources of uncertainty. In some embodiments, calculation module 222 may calculate a probability distribution. Additionally or alternatively, calculation module 222 may calculate an ETA range. In some embodiments, calculation module 222 may weight each source of uncertainty and calculate an overall uncertainty metric based on weighted input from the various sources of uncertainty. In some embodiments, a matching module 224 may make a matching decision involving requestor device 216 and/or provider device 218 based at least in part on statistical metric 226. For example, matching module 224 may match requestor device 216 and provider device 218 in response to determining that statistical metric 226 indicates that the overall uncertainty is below a threshold for acceptable uncertainty. In another example, matching module 224 may not match requestor device 216 and provider device 218 in response to determining that statistical metric 226 indicates that overall uncertainty is above a threshold for acceptable uncertainty.

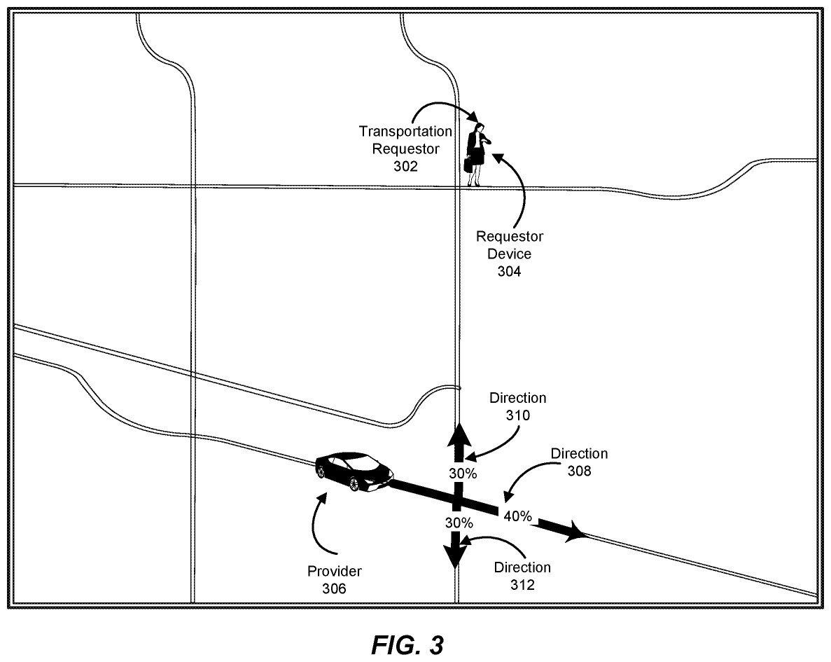

FIG. 3 illustrates an example scenario involving a transportation requestor and a transportation provider. In one example, a transportation requestor 302 may send a request for transportation from a requestor device 304. In some examples, a provider 306 may be within a reasonable distance of transportation requestor 302 but may be approaching an intersection. In one example, provider 306 may have the option of turning in direction 308, 310, or 312. In some embodiments, the systems described herein may determine the probability of provider 306 turning in each direction based on the previous behavior of provider 306 and/or other providers. For example, if similar providers historically turn right at this location 30% of the time during the same time of day and/or week, the systems described herein may determine that the probability of provider 306 turning right is 30%. In some embodiments, the systems described herein may use machine learning techniques and/or statistical analysis to determine the probability that provider 306 will take a given action. Additionally or alternatively, the systems described herein may determine the probability of provider 306 turning in each direction based on route information for other trips being completed by provider 306 (e.g., if provider 306 is a shared provider currently transporting one or more requestors to a known destination). In one example, the systems described herein may predict that provider 306 has a 30% chance of turning in direction 310, a 40% chance of continuing straight in direction 308, and/or a 30% chance of turning in direction 312. In one example, this might represent an ETA of eight minutes if provider 306 turns in direction 310, an ETA of 12 minutes of provider 306 turns in direction 308, and/or an ETA of 22 minutes if provider 306 turns in direction 312. In some embodiments, because the turning direction of provider 306 is so uncertain (because the probabilities are relatively even), the systems described herein may determine that provider 306 has an ETA with high uncertainty. In another example, if the probability of provider 306 continuing in direction 308 were 90% (e.g., because provider 306 was transporting a requestor to a destination in that direction), the systems described herein may determine that provider 306 has an ETA with lower uncertainty and/or that provider 306 has an unfavorable ETA due to provider 306 moving away from transportation requestor 302. In another example, if provider 306 had an 80% probability of turning in direction 310, the systems described herein may determine that provider 306 has a low uncertainty and a favorable ETA. In some examples, provider 306 may be far enough from the intersection that it is possible but not guaranteed for provider 306 to respond to directions to meet transportation requestor 302 (e.g., by turning left). In these examples, the systems described herein may factor uncertainty about the response time of provider 306 into the overall uncertainty metric.

In some embodiments, the systems described herein may delay matching provider 306 due to the high uncertainty surrounding the direction in which provider 306 will turn and/or the low duration of the uncertainty (i.e., because provider 306 will enter the intersection soon). For example, if provider 306 has a relatively even probability of turning in any direction but is expected to pass the intersection within two seconds, the systems described herein may delay matching provider 306 by two seconds in order to have a more accurate ETA for provider 306 and/or in order to determine whether provider 306 is the optimal provider to match to requestor device 304. In some embodiments, the systems described herein may also delay matching requestor device 304 with any transportation provider device while determining whether provider 306 is suitable for matching. In other embodiments, the systems described herein may match requestor device 304 with a different provider device (e.g., on associated with a provider with lower uncertainty) and may delay matching provider 306 with any requestor device. Although discussed in terms of an intersection, in some examples, provider 306 may be approaching a decision point other than an intersection. For example, the systems described herein may behave similarly if provider 306 is approaching a freeway onramp, offramp, and/or junction. In some embodiments, the systems described herein may delay matching provider 306 if provider 306 is affected by any source of uncertainty with a characteristic and/or type that indicates the source of uncertainty will be resolved within a predetermined time frame. For example, the systems described herein may delay matching provider 306 if the most recent location data from provider 306 is fifty seven seconds old and new location data is expected to be received within the next three seconds.

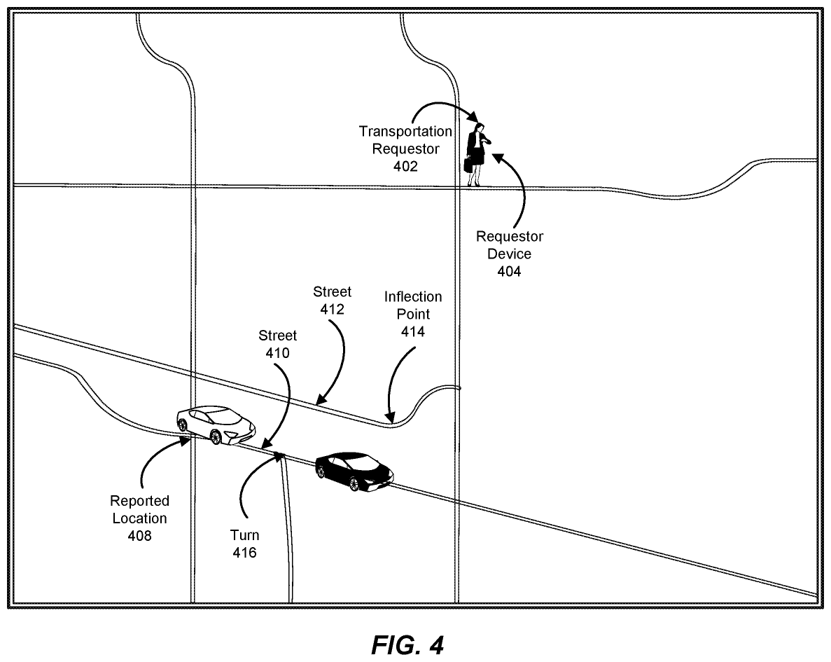

FIG. 4 illustrates an example scenario involving a transportation requestor and a transportation provider. In one example, a transportation requestor 402 may send a request for transportation from a requestor device 404. In some examples, a provider 406 may be within a reasonable distance of transportation requestor 402 but the dynamic transportation matching system may have low confidence in the accuracy of location information for provider 406. In some examples, the dynamic transportation matching system may estimate the accuracy of location information based on an accuracy metric provided by a vendor of a location system (e.g., a global positioning system). In some examples, the dynamic transportation matching system may have low confidence in the accuracy of location information for provider 406 due to information staleness. For example, the dynamic transportation matching system may have received location information that provider 406 was at reported location 408 ten seconds ago, but may not have received location information since. In some examples, the dynamic transportation matching system may attempt to predict the current location of provider 406 and/or may assign a probability to the likelihood that provider 406 slowed down, sped up, stopped, turned, and/or maintained the same speed since last reporting location data. In one example, provider 406 may have an ETA of eight minutes if provider 406 maintained speed and/or an ETA of 12 minutes of provider 406 stopped at reported location 408. In one example, the dynamic transportation matching system may calculate uncertainty about the location of provider 406 based on the length of time since location data was received about provider 406 and/or the amount of possible changes that could have occurred in the state of provider 406 (e.g., made a turn, entered a freeway, stopped to pick up a requestor) since location information was received. In one embodiment, the systems described herein may not have information on whether or not provider 406 has continued straight or made turn 416. In some examples, provider 406 may have an ETA of eight minutes if provider 406 continued forward but an ETA of 22 minutes if provider 406 made turn 416. In some examples, the dynamic transportation matching system may delay matching provider 406 until receiving updated location information for provider 406.

Additionally or alternatively, the dynamic transportation matching system may be uncertain about the location of provider 406 due to inaccurate geolocation service (e.g., global positioning system) and/or map data. For example, if provider 406 is traversing a street 410 that is parallel to a street 412, the dynamic transportation matching system may be uncertain about whether provider 406 is on street 410 or street 412. In one example, street 412 may have an inflection point 414 at which street 412 ceases to be parallel to street 410. In some examples, the dynamic transportation matching system may delay matching provider 406 until provider 406 passes inflection point 414, after which the uncertainty about the location of provider 406 may be reduced. In other examples, the dynamic transportation matching system may not delay matching provider 406 but may factor uncertainty about the exact location of provider 406 into the overall uncertainty metric for provider 406.

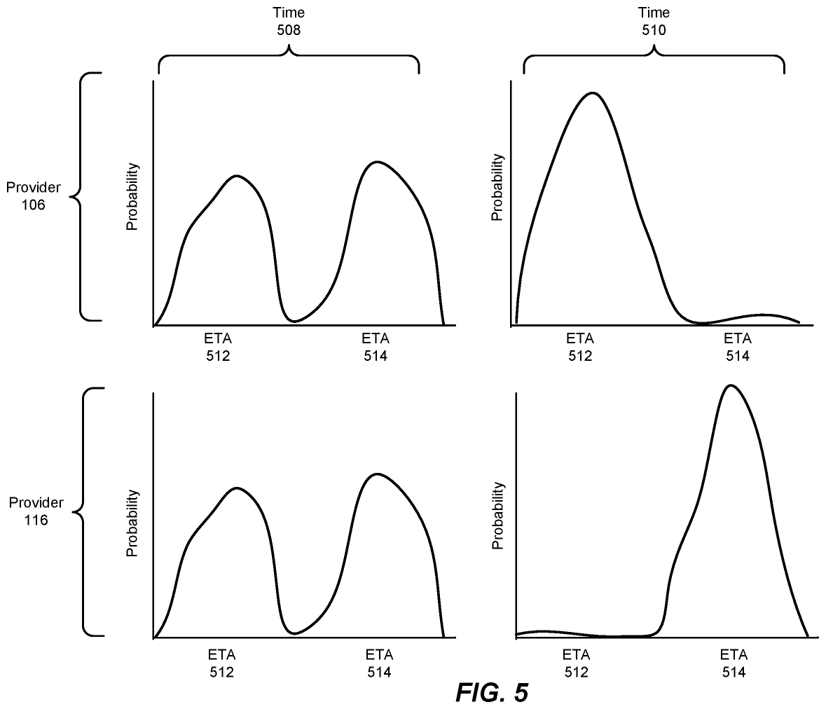

FIG. 5 illustrates a set of probability graphs for two transportation providers that show different probability distributions for each provider at different times. For example, provider 106 and/or provider 116 in FIG. 1 may be roughly equally likely to be moving in one of two directions, towards either a first location (e.g., the location a transportation requestor such as transportation requestor 102 in FIG. 1) or a second location. In one example, moving in the direction of the first location may yield an ETA 512 for meeting the transportation requestor and/or moving in the direction of the second location may yield an ETA 514 for meeting the transportation requestor. In some examples, ETA 512 may be significantly shorter than ETA 514. For example, ETA 512 may be five minutes while ETA 514 may be twenty minutes. In some examples, at time 508, it may not be clear whether it is more efficient for a dynamic transportation matching system to match provider 106 or provider 116 with a requestor at the first location. The probability distributions from provider 106 and/or 116 may arise from a variety of sources of uncertainty, including uncertainty about the exact location of one or both providers, uncertainty about route prediction for one or both providers, and/or uncertainty about the accuracy of map data in the area occupied by one or both providers. In some examples, the dynamic transportation matching system may delay matching for the requestor until a clear match is available. In one example, at time 510, the dynamic transportation matching system may receive information (e.g., updated location information that gives a clearer picture of provider location, direction of travel, and/or speed) that makes it clear that provider 106 is heading towards the first location, resulting in ETA 512 and/or provider 116 is heading towards the second location, resulting in ETA 514. In some examples, at time 510, the dynamic transportation matching system may match one or both providers with requestors based at least in part on the low uncertainty about the ETA of the providers to meet the requestors. For example, the dynamic transportation matching system may match a provider with a requestor based on the uncertainty of the ETA falling below a threshold for certainty. In some examples, a low uncertainty may be any uncertainty below a threshold of 30%, 25%, 10%, and/or 5%. Additionally or alternatively, an ETA with a low uncertainty may include any ETA where the maximum and minimum high-probability (e.g., greater than 90% probability) ETAs are within a specified range, such as within two minutes, within five minutes, and/or within ten minutes.

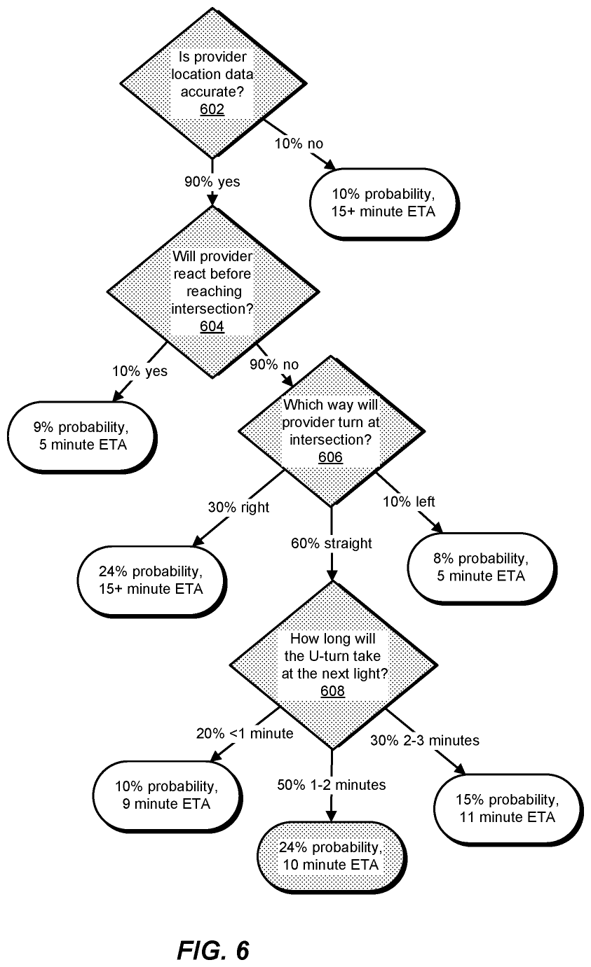

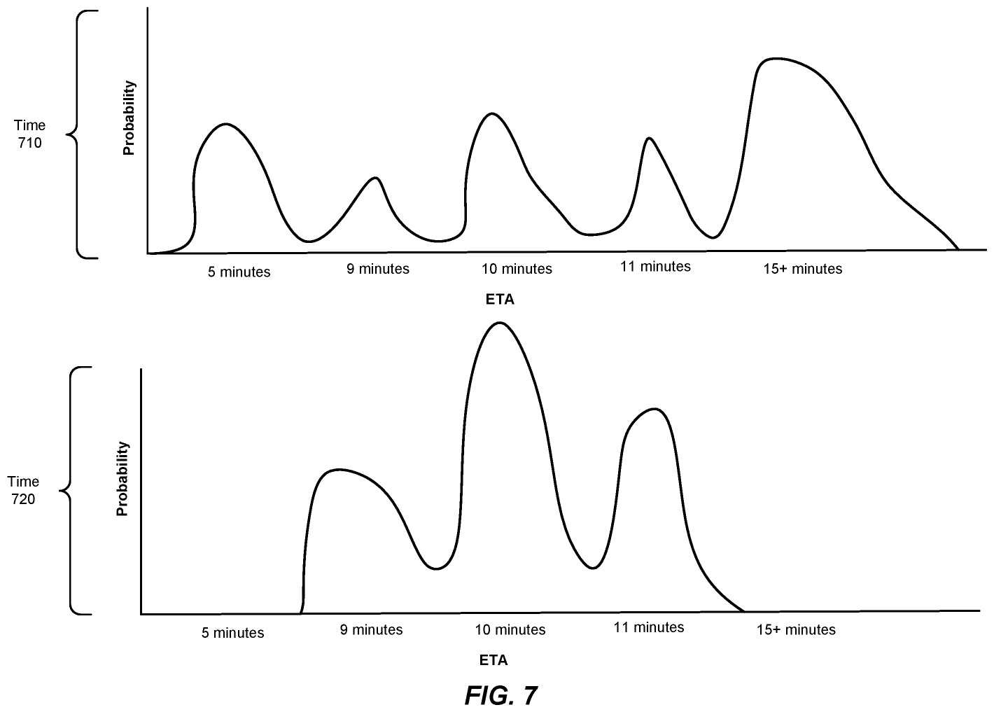

FIG. 6 is a flow diagram of an example probability tree. In some embodiments, the systems described herein may estimate branching probabilities for various outcomes. In one example, a provider may be located in an area with tunnels, one-way streets, and/or other navigational impediments that make wrong turns very costly in terms of time. For example, at decision point 602, the systems described herein may estimate the probability that the provider location data available to the dynamic transportation matching system is accurate. In one example, if the location data is inaccurate (e.g., the provider is one street over), the systems described herein may estimate that the provider has an unsuitably high ETA of at least fifteen minutes. If the location data is accurate, at decision point 604, the systems described herein may estimate, based on the distance between the provider and an intersection and/or historical provider reaction time, if the provider will receive and act on directions to meet a transportation requestor before reaching the intersection. If the provider does so, the systems described herein may predict an ETA of five minutes. If the provider does not, at decision point 606, the systems described herein may predict, based on past behavior for the provider and/or other providers at this and/or similar intersections, which way the provider will turn. If the provider turns left, the provider may have coincidentally selected the right direction and may have a five minute ETA. If the provider turns right, the provider may enter a tunnel or bridge and have an unsuitably high ETA. If the provider turns straight, at decision point 608, the systems described herein may attempt to predict how long it will take the provider to complete a U-turn at the next traffic light based on historical timing data for that traffic light and/or similar traffic lights. In some embodiments, the systems described herein may calculate probabilities for the entire tree before matching the provider. In one example, as illustrated in FIG. 7, at time 710 the systems described herein may calculate that there is a total of a 17% probability that the provider arrives in five minutes, a 10% probability that the provider arrives in nine minutes, a 24% probability that the provider arrives in ten minutes, a 15% probability that the provider arrives in eleven minutes, and a 34% probability that the provider will take longer than fifteen minutes to arrive at the meeting point with the transportation requestor. In one example, at time 720, the systems described herein may receive information indicating that the provider continued straight at the intersection. The systems described herein may then calculate a 20% probability of a nine minute ETA, a 50% probability of a 10 minute ETA, and/or a 30% probability of an 11 minute ETA.

In some embodiments, the systems described herein may decline to match the provider based on calculating that there is an unacceptably high (e.g., greater than 30%) probability that the provider will have an unsuitably high ETA. In one embodiment, the decision to match may be dependent on what other providers are available and/or what the probability distributions for those providers are, how long until the uncertainties for those ETA estimates will be clarified for the one or more providers, and/or the probability that a different provider will become available that will have a more certain and/or better ETA for the request. In some examples, the systems described herein may match the provider with the requestor based at least in part on the 67% probability that the provider will arrive in eleven minutes or less. In one embodiment, the systems described herein may average some or all of the probabilities to produce an ETA estimate and/or range to provide to the transportation requestor. For example, the systems described herein may provide an ETA range of 8+/−3 minutes. In one example, the provider may fail to react in time to the directions, continue straight through the intersection, and make a U-turn at a medium-length traffic light, resulting in an actual time of arrival of ten minutes, within the ETA range provided to the transportation requestor.

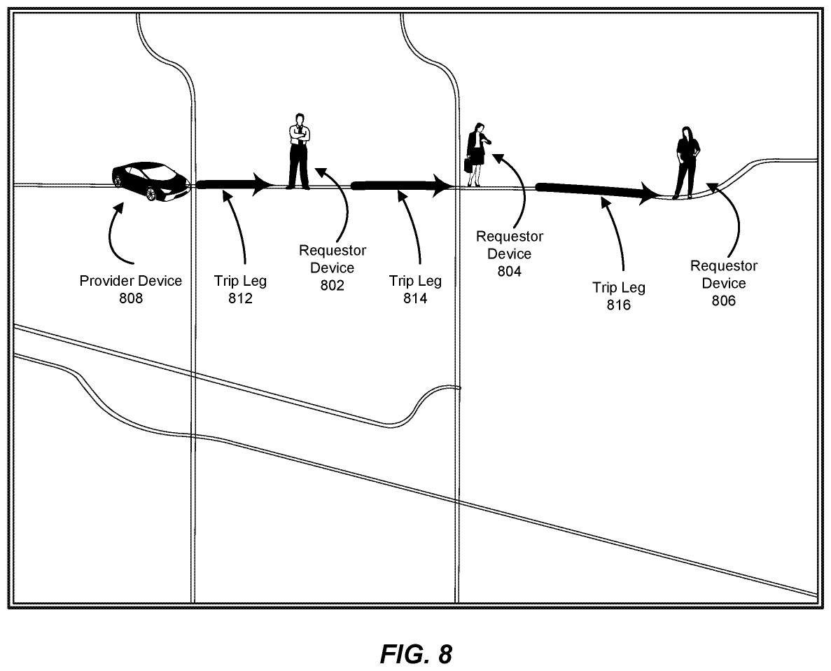

FIG. 8 illustrates an example scenario where several transportation requestors share a transportation provider. In one example, a provider device 808 may traverse a trip leg 812 to meet a requestor device 802, a trip leg 814 to meet a requestor device 804, and/or a trip leg 816 to meet a requestor device 806. In some examples, trip legs 812, 814, and/or 814 may all be subject to uncertainty, compounding the uncertainty of the ETAs provided to requestor devices later in line and/or the uncertainty of estimated times to destination (ETDs) provided to earlier requestor devices. In addition to the sources of uncertainty discussed above, shared trips may introduce an additional source of uncertainty based on the behavior of requestors. For example, if the requestor associated with requestor device 804 is late meeting provider device 808, the ETA provided to requestor device 806 may no longer be accurate due to the delay. In some examples, the provider associated with provider device 808 may have difficulty finding a safe spot to pull over and meet a requestor. In some embodiments, the dynamic transportation matching system may predict the delay associated with requestor pickups during a shared trip based on previous requestor behavior (e.g., is the requestor typically late or typically on time). Additionally or alternatively, the dynamic transportation network may predict and/or model the delay associated with a pickup location at a given time based on previous delay associated with that pickup location and/or similar pickup locations (e.g., downtown areas versus rural areas and/or intersections versus one-way streets) at similar times (e.g., pickups during rush hour may experience more delay than pickups at night when there is less traffic). By predicting the delay associated with meeting requestors, the dynamic transportation matching system may produce more accurate ETAs and/or ETAs and/or may more accurately determine the uncertainty associated with ETAs and/or ETDs. In one example, the dynamic transportation matching system may factor in uncertainty associated with trip legs 812, 814, and 816 and pickups for requestors associated with requestor devices 802 and 804 when determining the overall uncertainty for the ETA to provide to requestor device 806. In some examples, the systems described herein may perform different matching based on the ETA uncertainty information than would happen without the ETA uncertainty information. For example, without ETA uncertainty information, the systems described herein may calculate that provider device 808 will arrive at requestor device 806 sufficiently quickly to justify matching provider device 808 with requestor device 806. However, with ETA uncertainty information, the systems described herein may determine that provider device 808 does not have a sufficiently high probability of arriving at requestor device 806 within an acceptable time frame (e.g., ten minutes) to justify matching requestor device 806 with provider device 808. In some examples, the systems described herein may delay matching a requestor device to an existing multi-leg trip due to a high level of uncertainty. In some embodiments, the dynamic transportation matching system may match requestor devices and provider devices for shared trips based on worst-case-scenario ETDs. Additionally or alternatively, the dynamic transportation matching system may provide worst-case-scenario ETDs to requestor devices and/or may provide ETDs that are above a probability threshold of being achieved or beaten (e.g., there is a 100% chance the requestor will arrive at the destination at or before the provided ETD). In some embodiments, the dynamic transportation matching system may factor in uncertainty associated with multiple types of trip leg (e.g., a requestor walking to a personal mobility vehicle and then using the personal mobility vehicle to meet a provider) when calculating ETAs and/or ETDs.

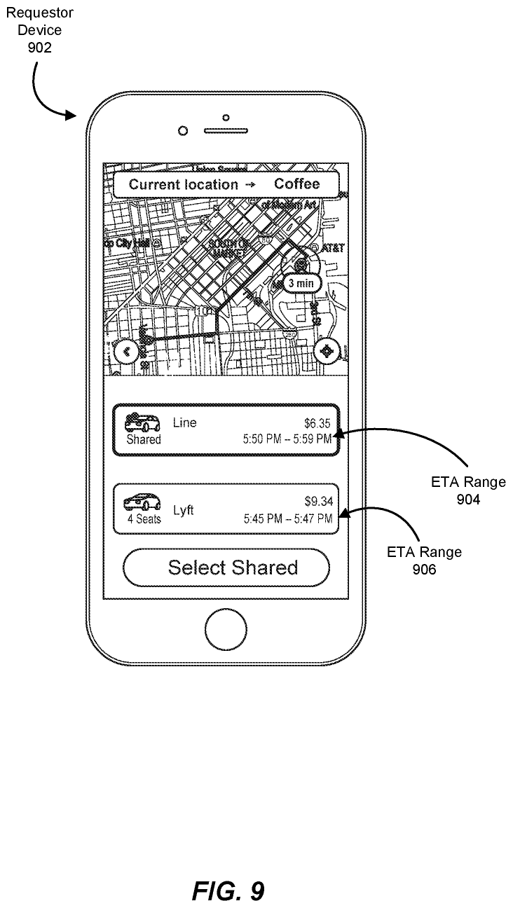

FIG. 9 illustrates an example requestor device displaying ETA uncertainty information. In some examples, the systems described herein may provide a requestor device 902 with a range of possible ETAs for one or more transportation options. For example, the systems described herein may provide requestor device 902 with an ETA range 904 for a shared ride and/or an ETA range 906 for a private trip. In some embodiments, the systems described herein may include the range of all predicted ETAs in an ETA range. Additionally or alternatively, the systems described herein may include a range of all ETAs above a certain probability (e.g., 30%).

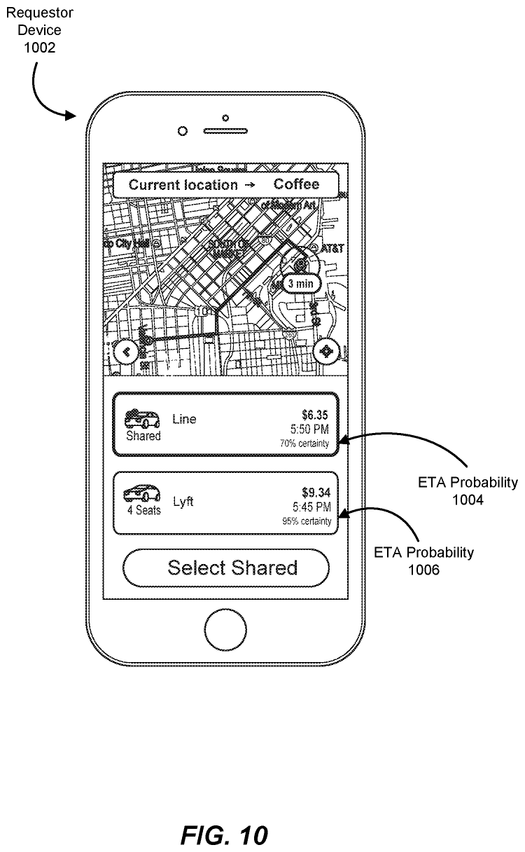

FIG. 10 illustrates an example requestor device displaying ETA uncertainty information. In some examples, the systems described herein may provide a requestor device 1002 with ETA confidence information for one or more transportation options. For example, the systems described herein may provide requestor device 1002 with an ETA probability 1004 for a shared ride and/or an ETA probability 1006 for a private trip. In some embodiments, the systems described herein may calculate the ETA with the highest probability and then provide the requestor device with that ETA and the calculated probability of that ETA being correct.

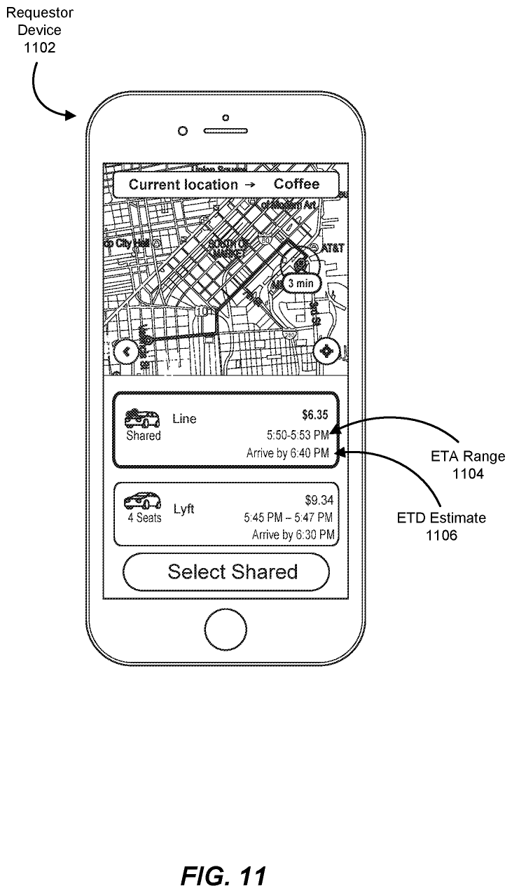

FIG. 11 illustrates an example requestor device displaying ETA uncertainty information and ETD information. In some examples, the systems described herein may provide a requestor device 1102 with ETA range information and/or ETD information for one or more transportation options. For example, the systems described herein may provide requestor device 1102 with an ETA range 1104 and/or an ETD estimate 1106. In some embodiments, the systems described herein may use similar sources of uncertainty and/or uncertainty calculation algorithms to calculate an ETD as to calculate an ETA. In some examples, the systems described herein may display a conservative ETD estimate (i.e., an ETD estimate with a high probability of being achieved). In some examples, the systems described herein may provide an ETD probability and/or ETD range.

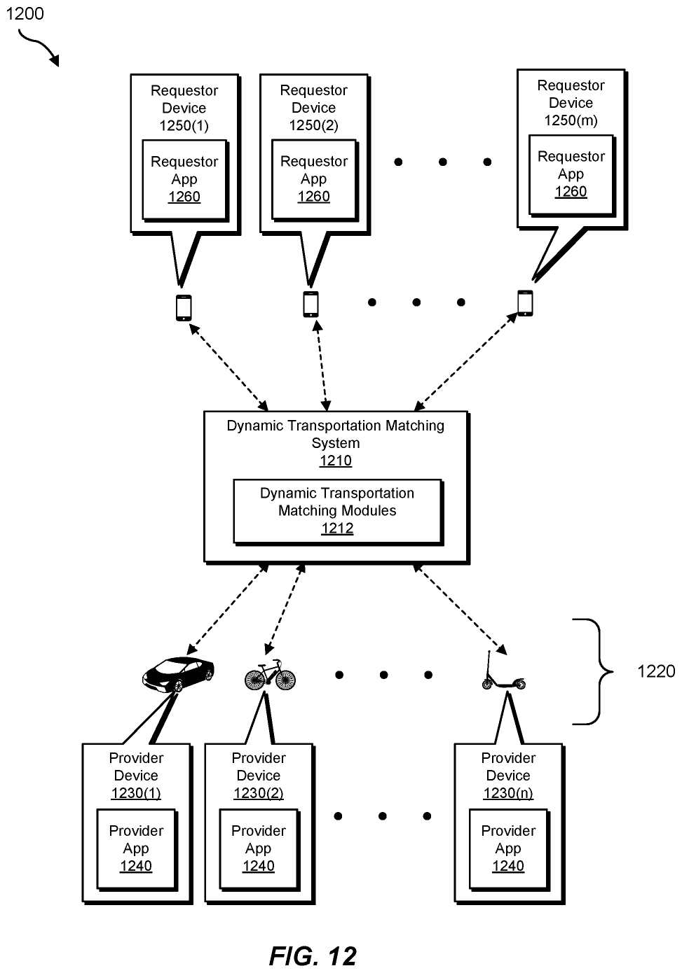

FIG. 12 illustrates an example system 1200 for matching transportation requests with a dynamic transportation network that includes personal mobility vehicles. As shown in FIG. 12, a dynamic transportation matching system 1210 may be configured with one or more dynamic transportation matching modules 1212 that may perform one or more of the steps described herein. Dynamic transportation matching system 1210 may represent any computing system and/or set of computing systems capable of matching transportation requests. Dynamic transportation matching system 1210 may be in communication with computing devices in each of a group of vehicles 1220. Vehicles 1220 may represent any vehicles that may fulfill transportation requests. In some examples, vehicles 1220 may include disparate vehicle types and/or models. For example, vehicles 1220 may include road-going vehicles and personal mobility vehicles. In some examples, some of vehicles 1220 may be standard commercially available vehicles. According to some examples, some of vehicles 1220 may be owned by separate individuals (e.g., transportation providers). Furthermore, while, in some examples, many or all of vehicles 1220 may be human-operated, in some examples many of vehicles 1220 may also be autonomous (or partly autonomous). Accordingly, throughout the instant disclosure, references to a “transportation provider” (or “provider”) may, where appropriate, refer to an operator of a human driven vehicle, an autonomous vehicle control system, an autonomous vehicle, an owner of an autonomous vehicle, an operator of an autonomous vehicle, an attendant of an autonomous vehicle, a vehicle piloted by a requestor, and/or an autonomous system for piloting a vehicle. While FIG. 12 does not specify the number of vehicles 1220, it may be readily appreciated that the systems described herein are applicable to hundreds of vehicles, thousands of vehicles, or more. In one example, dynamic transportation matching system 1210 may coordinate transportation matchings within a single region for 50,000 vehicles or more on a given day. In some examples, vehicles 1220 may collectively form a dynamic transportation network that may provide transportation supply on an on-demand basis to transportation requestors.

As mentioned above, dynamic transportation matching system 1210 may communicate with computing devices in each of vehicles 1220. The computing devices may be any suitable type of computing device. In some examples, one or more of the computing devices may be integrated into the respective vehicles 1220. In some examples, one or more of the computing devices may be mobile devices. For example, one or more of the computing devices may be smartphones. Additionally or alternatively, one or more of the computing devices may be tablet computers, personal digital assistants, or any other type or form of mobile computing device. According to some examples, one or more of the computing devices may include wearable computing devices (e.g., a driver-wearable computing device), such as smart glasses, smart watches, etc. In some examples, one or more of the computing devices may be devices suitable for temporarily mounting in a vehicle (e.g., for use by a requestor and/or provider for a transportation matching application, a navigation application, and/or any other application suited for the use of requestors and/or providers). Additionally or alternatively, one or more of the computing devices may be devices suitable for installing in a vehicle and/or may be a vehicle's computer that has a transportation management system application installed on the computer in order to provide transportation services to transportation requestors and/or communicate with dynamic transportation matching system 1210.

As shown in FIG. 12, vehicles 1220 may include provider devices 1230(1)-(n) (e.g., whether integrated into the vehicle, permanently affixed to the vehicle, temporarily affixed to the vehicle, worn by a driver of the vehicle, etc.). In some examples, provider devices 1230 may include a provider apps 1240(1)-(k). Provider apps 1240(1)-(k) may represent any application, program, and/or module that may provide one or more services related to operating a vehicle and/or providing transportation matching services. For example, provider apps 1240(1)-(k) may include a transportation matching application for providers and/or one or more applications for matching personal mobility vehicles (PMVs) with requestor devices. In some embodiments, different types of provider vehicles may be provisioned with different types of provider devices and/or different provider applications. For example, PMVs may be provisioned with provider devices that are configured with a provider application that enables transportation requestors to reserve and/or operate the PMV while road-constrained vehicles (e.g., cars) may be provisioned with provider devices that are configured with a provider application that enables provider vehicle operators (e.g., transportation providers) to respond to requests from transportation requestors. In some examples, provider applications 1240(1)-(k) may match the user of provider apps 1240(1)-(k) (e.g., a transportation provider) with transportation requestors through communication with dynamic transportation matching system 1210. In addition, and as is described in greater detail below, provider apps 1240(1)-(k) may provide dynamic transportation management system 1210 with information about a provider (including, e.g., the current location of the provider and/or vehicle) to enable dynamic transportation management system 1210 to provide dynamic transportation matching and/or management services for the provider and one or more requestors. In some examples, provider apps 1240(1)-(k) may coordinate communications and/or a payment between a requestor and a provider. According to some embodiments, provider apps 1240(1)-(k) may provide a map service, a navigation service, a traffic notification service, and/or a geolocation service.

Additionally, as shown in FIG. 12, dynamic transportation matching system 1210 may communicate with requestor devices 1250(1)-(m). In some examples, requestor devices 1250 may include a requestor app 1260. Requestor app 1260 may represent any application, program, and/or module that may provide one or more services related to requesting transportation matching services. For example, requestor app 1260 may include a transportation matching application for requestors. In some examples, requestor app 1260 may match the user of requestor app 1260 (e.g., a transportation requestor) with transportation providers through communication with dynamic transportation matching system 1210. In addition, and as is described in greater detail below, requestor app 1260 may provide dynamic transportation management system 1210 with information about a requestor (including, e.g., the current location of the requestor) to enable dynamic transportation management system 1210 to provide dynamic transportation matching services for the requestor and one or more providers. In some examples, requestor app 1260 may coordinate communications and/or a payment between a requestor and a provider. According to some embodiments, requestor app 1260 may provide a map service, a navigation service, a traffic notification service, and/or a geolocation service.

Embodiments of the instant disclosure may include or be implemented in conjunction with a dynamic transportation matching system. A transportation matching system may arrange transportation on an on-demand and/or ad-hoc basis by, e.g., matching one or more transportation requestors with one or more transportation providers. For example, a transportation matching system may provide one or more transportation matching services for a ridesharing service, a ridesourcing service, a taxicab service, a car-booking service, an autonomous vehicle service, a personal mobility vehicle service, or some combination and/or derivative thereof. The transportation matching system may include and/or interface with any of a variety of subsystems that may implement, support, and/or improve a transportation matching service. For example, the transportation matching system may include a matching system (e.g., that matches requestors to ride opportunities and/or that arranges for requestors and/or providers to meet), a mapping system, a navigation system (e.g., to help a provider reach a requestor, to help a requestor reach a provider, and/or to help a provider reach a destination), a reputation system (e.g., to rate and/or gauge the trustworthiness of a requestor and/or a provider), a payment system, and/or an autonomous or semi-autonomous driving system. The transportation matching system may be implemented on various platforms, including a requestor-owned mobile device, a computing system installed in a vehicle, a requestor-owned mobile device, a server computer system, or any other hardware platform capable of providing transportation matching services to one or more requestors and/or providers.

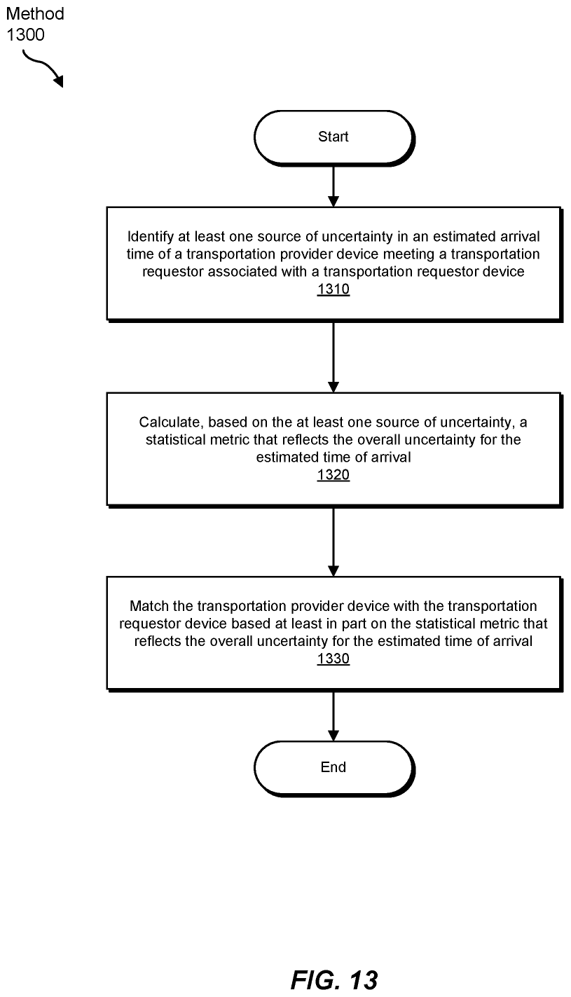

FIG. 13 illustrates an example method 1300 for uncertainty-aware matching of transportation requestors and providers. As illustrated in FIG. 13, at step 1310, one or more of the systems described herein may identify at least one source of uncertainty in an ETA of a transportation provider device meeting a transportation requestor associated with a transportation requestor device.

In one embodiment, the at least one source of uncertainty may include potentially inaccurate geolocation information for the transportation provider device used to produce the ETA. In some embodiments, the at least one source of uncertainty may include out-of-date geolocation information for the transportation provider device used to produce the ETA.

Additionally or alternatively, the at least one source of uncertainty may include potentially inaccurate route information for the transportation requestor device used to produce the ETA. In one embodiment, the potentially inaccurate route information may be potentially inaccurate due at least in part to a probability that an operator of the transportation provider device will make a navigation decision that alters the ETA before responding to routing directions to meet the transportation requestor device that are sent to the transportation provider device.

In one example, the at least one source of uncertainty may include potential inaccuracy introduced by an ETA prediction algorithm used to produce the ETA. In some examples, the at least one source of uncertainty may include potentially inaccurate map information used to produce the ETA.

At step 1320, one or more of the systems described herein may calculate, based on the at least one source of uncertainty, a statistical metric that reflects the overall uncertainty for the ETA.

In one embodiment, the systems described herein may calculate, based on the at least one source of uncertainty, the statistical metric that reflects the overall uncertainty for the ETA by assigning a weight to each source of uncertainty in the at least source of uncertainty and calculating the statistical metric that reflects the overall uncertainty based at least in part on the weight of each source of uncertainty. In one embodiment, the statistical metric that reflects the overall uncertainty may include a probability distribution for the ETA.

At step 1330, one or more of the systems described herein may match the transportation provider device with the transportation requestor device based at least in part on the statistical metric that reflects the overall uncertainty for the ETA.

In some examples, the systems described herein may match the transportation provider device with the transportation requestor device based at least in part on the statistical metric that reflects the overall uncertainty for the ETA by predicting, based on a characteristic of the at least one source of uncertainty, a decrease of the overall uncertainty within a predetermined time frame and delaying matching the transportation provider device with the transportation requestor device until the overall uncertainty decreases based at least in part on predicting that the overall uncertainty will decrease within the predetermined time frame. In some examples, the systems described herein may match the transportation provider device with the transportation requestor device based at least in part on the statistical metric that reflects the overall uncertainty for the ETA by determining that the overall uncertainty is within a predetermined threshold for acceptable uncertainty.

Additionally or alternatively, the systems described herein may match the transportation provider device with the transportation requestor device based at least in part on the statistical metric that reflects the overall uncertainty for the ETA by (i) identifying a first transportation provider device with a first ETA and a first overall uncertainty, (ii) identifying a second transportation provider device with a second ETA that is later than the first ETA and a second overall uncertainty that is less than the first overall uncertainty, and (iii) matching the second transportation provider device with the transportation requestor device based on the second overall uncertainty being less than the first overall uncertainty despite the second ETA being later than the first ETA. In one embodiment, systems described herein display, on the transportation requestor device, a representation of the overall uncertainty.

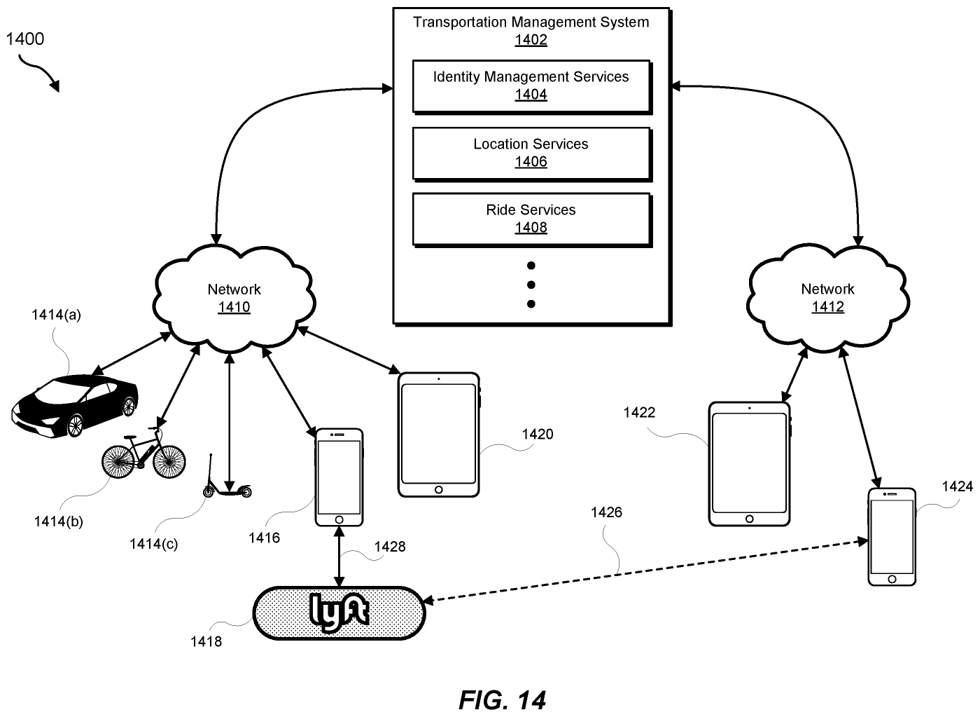

FIG. 14 shows a transportation management environment 1400, in accordance with various embodiments. As shown in FIG. 14, a transportation management system 1402 may run one or more services and/or software applications, including identity management services 1404, location services 1406, ride services 1408, and/or other services. Although FIG. 14 shows a certain number of services provided by transportation management system 1402, more or fewer services may be provided in various implementations. In addition, although FIG. 14 shows these services as being provided by transportation management system 1402, all or a portion of any of the services may be processed in a distributed fashion. For example, computations associated with a service task may be performed by a combination of transportation management system 1402 (including any number of servers, databases, etc.), one or more devices associated with a provider (e.g., devices integrated with managed vehicles 1414(a), 1414(b), and/or 1414(c); provider computing devices 1416 and tablets 1420; and transportation management vehicle devices 1418), and/or more or more devices associated with a ride requestor (e.g., the requestor's computing devices 1424 and tablets 1422). In some embodiments, transportation management system 1402 may include one or more general purpose computers, server computers, clustered computing systems, cloud-based computing systems, and/or any other computing systems or arrangements of computing systems. Transportation management system 1402 may be configured to run any or all of the services and/or software components described herein. In some embodiments, the transportation management system 1402 may include an appropriate operating system and/or various server applications, such as web servers capable of handling hypertext transport protocol (HTTP) requests, file transfer protocol (FTP) servers, database servers, etc.

In some embodiments, identity management services 1404 may be configured to perform authorization services for requestors and providers and/or manage their interactions and/or data with transportation management system 1402. This may include, e.g., authenticating the identity of providers and determining that they are authorized to provide services through transportation management system 1402. Similarly, requestors' identities may be authenticated to determine whether they are authorized to receive the requested services through transportation management system 1402. Identity management services 1404 may also manage and/or control access to provider and/or requestor data maintained by transportation management system 1402, such as driving and/or ride histories, vehicle data, personal data, preferences, usage patterns as a ride provider and/or as a ride requestor, profile pictures, linked third-party accounts (e.g., credentials for music and/or entertainment services, social-networking systems, calendar systems, task-management systems, etc.) and any other associated information. Transportation management system 1402 may also manage and/or control access to provider and/or requestor data stored with and/or obtained from third-party systems. For example, a requester or provider may grant transportation management system 1402 access to a third-party email, calendar, or task management system (e.g., via the user's credentials). As another example, a requestor or provider may grant, through a mobile device (e.g., 1416, 1420, 1422, or 1424), a transportation application associated with transportation management system 1402 access to data provided by other applications installed on the mobile device. In some examples, such data may be processed on the client and/or uploaded to transportation management system 1402 for processing.

In some embodiments, transportation management system 1402 may provide ride services 1408, which may include ride matching and/or management services to connect a requestor to a provider. For example, after identity management services module 1404 has authenticated the identity a ride requestor, ride services module 1408 may attempt to match the requestor with one or more ride providers. In some embodiments, ride services module 1408 may identify an appropriate provider using location data obtained from location services module 1406. Ride services module 1408 may use the location data to identify providers who are geographically close to the requestor (e.g., within a certain threshold distance or travel time) and/or who are otherwise a good match with the requestor. Ride services module 1408 may implement matching algorithms that score providers based on, e.g., preferences of providers and requestors; vehicle features, amenities, condition, and/or status; providers' preferred general travel direction and/or route, range of travel, and/or availability; requestors' origination and destination locations, time constraints, and/or vehicle feature needs; and any other pertinent information for matching requestors with providers. In some embodiments, ride services module 1408 may use rule-based algorithms and/or machine-learning models for matching requestors and providers.

Transportation management system 1402 may communicatively connect to various devices through networks 1410 and/or 1412. Networks 1410 and 1412 may include any combination of interconnected networks configured to send and/or receive data communications using various communication protocols and transmission technologies. In some embodiments, networks 1410 and/or 1412 may include local area networks (LANs), wide-area networks (WANs), and/or the Internet, and may support communication protocols such as transmission control protocol/Internet protocol (TCP/IP), Internet packet exchange (IPX), systems network architecture (SNA), and/or any other suitable network protocols. In some embodiments, data may be transmitted through networks 1410 and/or 1412 using a mobile network (such as a mobile telephone network, cellular network, satellite network, or other mobile network), a public switched telephone network (PSTN), wired communication protocols (e.g., Universal Serial Bus (USB), Controller Area Network (CAN)), and/or wireless communication protocols (e.g., wireless LAN (WLAN) technologies implementing the IEEE 1102.12 family of standards, Bluetooth, Bluetooth Low Energy, Near Field Communication (NFC), Z-Wave, and ZigBee). In various embodiments, networks 1410 and/or 1412 may include any combination of networks described herein or any other type of network capable of facilitating communication across networks 1410 and/or 1412.

In some embodiments, transportation management vehicle device 1418 may include a provider communication device configured to communicate with users, such as drivers, passengers, pedestrians, and/or other users. In some embodiments, transportation management vehicle device 1418 may communicate directly with transportation management system 1402 or through another provider computing device, such as provider computing device 1416. In some embodiments, a requestor computing device (e.g., device 1424) may communicate via a connection 1426 directly with transportation management vehicle device 1418 via a communication channel and/or connection, such as a peer-to-peer connection, Bluetooth connection, NFC connection, ad hoc wireless network, and/or any other communication channel or connection. Although FIG. 14 shows particular devices communicating with transportation management system 1402 over networks 1410 and 1412, in various embodiments, transportation management system 1402 may expose an interface, such as an application programming interface (API) or service provider interface (SPI) to enable various third parties which may serve as an intermediary between end users and transportation management system 1402.

In some embodiments, devices within a vehicle may be interconnected. For example, any combination of the following may be communicatively connected: vehicle 1414, provider computing device 1416, provider tablet 1420, transportation management vehicle device 1418, requestor computing device 1424, requestor tablet 1422, and any other device (e.g., smart watch, smart tags, etc.). For example, transportation management vehicle device 1418 may be communicatively connected to provider computing device 1416 and/or requestor computing device 1424. Transportation management vehicle device 1418 may establish communicative connections, such as connections 1426 and 1428, to those devices via any suitable communication technology, including, e.g., WLAN technologies implementing the IEEE 1102.12 family of standards, Bluetooth, Bluetooth Low Energy, NFC, Z-Wave, ZigBee, and any other suitable short-range wireless communication technology.

In some embodiments, users may utilize and interface with one or more services provided by the transportation management system 1402 using applications executing on their respective computing devices (e.g., 1416, 1418, 1420, and/or a computing device integrated within vehicle 1414), which may include mobile devices (e.g., an iPhone®, an iPad®, mobile telephone, tablet computer, a personal digital assistant (PDA)), laptops, wearable devices (e.g., smart watch, smart glasses, head mounted displays, etc.), thin client devices, gaming consoles, and any other computing devices. In some embodiments, vehicle 1414 may include a vehicle-integrated computing device, such as a vehicle navigation system, or other computing device integrated with the vehicle itself, such as the management system of an autonomous vehicle. The computing device may run on any suitable operating systems, such as Android®, iOS®, macOS®, Windows®, Linux®, UNIX®, or UNIX®-based or Linux®-based operating systems, or other operating systems. The computing device may further be configured to send and receive data over the Internet, short message service (SMS), email, and various other messaging applications and/or communication protocols. In some embodiments, one or more software applications may be installed on the computing device of a provider or requestor, including an application associated with transportation management system 1402. The transportation application may, for example, be distributed by an entity associated with the transportation management system via any distribution channel, such as an online source from which applications may be downloaded. Additional third-party applications unassociated with the transportation management system may also be installed on the computing device. In some embodiments, the transportation application may communicate or share data and resources with one or more of the installed third-party applications.

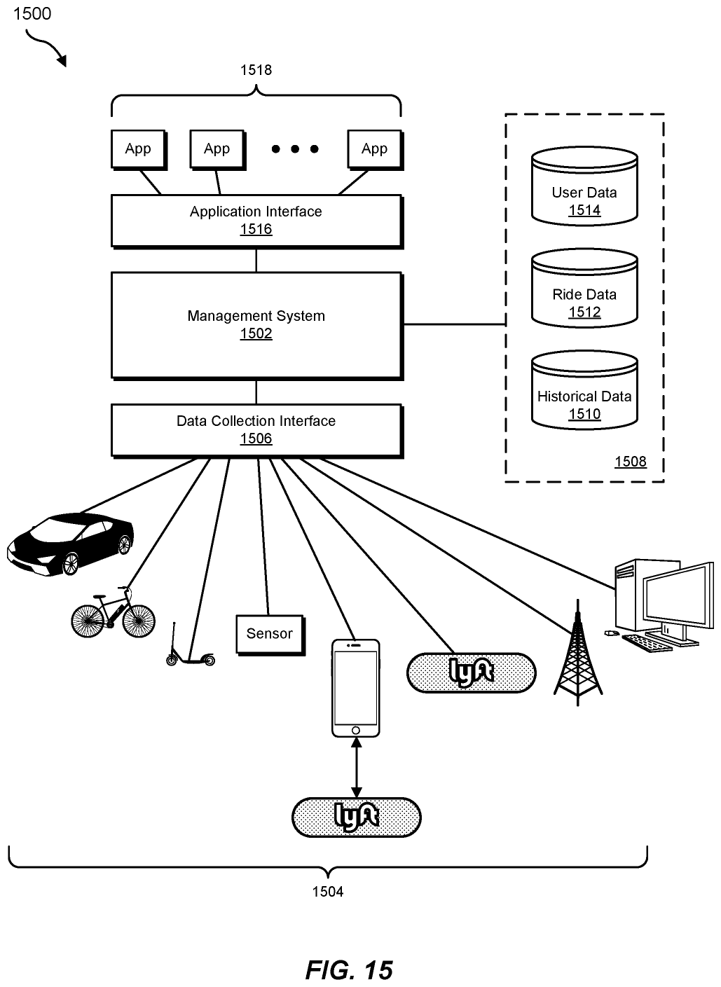

FIG. 15 shows a data collection and application management environment 1500, in accordance with various embodiments. As shown in FIG. 15, management system 1502 may be configured to collect data from various data collection devices 1504 through a data collection interface 1506. As discussed above, management system 1502 may include one or more computers and/or servers or any combination thereof. Data collection devices 1504 may include, but are not limited to, user devices (including provider and requestor computing devices, such as those discussed above), provider communication devices, laptop or desktop computers, vehicle data (e.g., from sensors integrated into or otherwise connected to vehicles), ground-based or satellite-based sources (e.g., location data, traffic data, weather data, etc.), or other sensor data (e.g., roadway embedded sensors, traffic sensors, etc.). Data collection interface 1506 can include, e.g., an extensible device framework configured to support interfaces for each data collection device. In various embodiments, data collection interface 1506 may be extended to support new data collection devices as they are released and/or to update existing interfaces to support changes to existing data collection devices. In various embodiments, data collection devices may communicate with data collection interface 1506 over one or more networks. The networks may include any network or communication protocol as would be recognized by one of ordinary skill in the art, including those networks discussed above.

As shown in FIG. 15, data received from data collection devices 1504 can be stored in data store 1508. Data store 1508 may include one or more data stores, such as databases, object storage systems and services, cloud-based storage services, and other data stores. For example, various data stores may be implemented on a non-transitory storage medium accessible to management system 1502, such as historical data store 1510, ride data store 1512, and user data store 1514. Data stores 1508 can be local to management system 1502, or remote and accessible over a network, such as those networks discussed above or a storage-area network or other networked storage system. In various embodiments, historical data 1510 may include historical traffic data, weather data, request data, road condition data, or any other data for a given region or regions received from various data collection devices. Ride data 1512 may include route data, request data, timing data, and other ride related data, in aggregate and/or by requestor or provider. User data 1514 may include user account data, preferences, location history, and other user-specific data. Although certain data stores are shown by way of example, any data collected and/or stored according to the various embodiments described herein may be stored in data stores 1508.

As shown in FIG. 15, an application interface 1516 can be provided by management system 1502 to enable various apps 1518 to access data and/or services available through management system 1502. Apps 1518 may run on various user devices (including provider and requestor computing devices, such as those discussed above) and/or may include cloud-based or other distributed apps configured to run across various devices (e.g., computers, servers, or combinations thereof). Apps 1518 may include, e.g., aggregation and/or reporting apps which may utilize data 1508 to provide various services (e.g., third-party ride request and management apps). In various embodiments, application interface 1516 can include an API and/or SPI enabling third party development of apps 1518. In some embodiments, application interface 1516 may include a web interface, enabling web-based access to data 1508 and/or services provided by management system 1502. In various embodiments, apps 1518 may run on devices configured to communicate with application interface 1516 over one or more networks. The networks may include any network or communication protocol as would be recognized by one of ordinary skill in the art, including those networks discussed above, in accordance with an embodiment of the present disclosure.

While various embodiments of the present disclosure are described in terms of a ridesharing service in which the ride providers are human drivers operating their own vehicles, in other embodiments, the techniques described herein may also be used in environments in which ride requests are fulfilled using autonomous vehicles. For example, a transportation management system of a ridesharing service may facilitate the fulfillment of ride requests using both human drivers and autonomous vehicles.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
identifying at least one source of uncertainty in an estimated arrival time of a transportation provider device meeting a transportation requestor associated with a transportation requestor device;
calculating, based on the at least one source of uncertainty, a statistical metric that reflects the uncertainty for the estimated time of arrival; and
matching the transportation provider device with the transportation requestor device based at least in part on the statistical metric that reflects the uncertainty for the estimated time of arrival meeting a certainty threshold.

2. The computer-implemented method of claim 1, wherein calculating, based on the at least one source of uncertainty, the statistical metric that reflects the uncertainty for the estimated time of arrival comprises:
assigning a weight to each source of uncertainty in the at least source of uncertainty; and
calculating the statistical metric that reflects the uncertainty based at least in part on the weight of each source of uncertainty.

3. The computer-implemented method of claim 1, wherein the statistical metric that reflects the uncertainty comprises a probability distribution for the estimated time of arrival.

4. The computer-implemented method of claim 1, wherein matching the transportation provider device with the transportation requestor device based at least in part on the statistical metric that reflects the uncertainty for the estimated time of arrival comprises:
predicting, based on a characteristic of the at least one source of uncertainty, within a predetermined time frame, a decrease of the uncertainty compared to a current value of the uncertainty; and
delaying matching the transportation provider device with the transportation requestor device until the uncertainty decreases in order to reduce uncertainty associated with matching the transportation requestor device.

5. The computer-implemented method of claim 4, wherein the characteristic of the at least one source of uncertainty comprises a type of source of uncertainty, wherein the type is associated with a predicted resolution time frame.

6. The computer-implemented method of claim 1, wherein matching the transportation provider device with the transportation requestor device based at least in part on the statistical metric that reflects the uncertainty for the estimated time of arrival comprises:
identifying a first transportation provider device with a first estimated time of arrival and a first uncertainty;
identifying a second transportation provider device with a second estimated time of arrival that is later than the first estimated time of arrival and a second uncertainty that is less than the first overall uncertainty; and
matching the second transportation provider device with the transportation requestor device based on the second uncertainty being less than the first uncertainty despite the second estimated time of arrival being later than the first estimated time of arrival.

7. The computer-implemented method of claim 1, wherein matching the transportation provider device with the transportation requestor device based at least in part on the statistical metric that reflects the uncertainty for the estimated time of arrival comprises:
identifying a first transportation provider device with a first estimated time of arrival and a first uncertainty;
identifying a second transportation provider device with a second estimated time of arrival and a second uncertainty; and
delaying matching either transportation provider device with the transportation requestor device based until at least one of the first uncertainty and the second uncertainty has decreased relative to a current value of the first uncertainty and the second uncertainty, respectively.

8. The computer-implemented method of claim 7, further comprising matching the first transportation provider device with the transportation requestor device in response to determining that the first uncertainty has decreased.

9. The computer-implemented method of claim 8, further comprising avoiding matching the first transportation provider device with the transportation requestor device despite the first uncertainty having decreased in response to determining that the first estimated time of arrival has increased.

10. The computer-implemented method of claim 1, wherein the at least one source of uncertainty comprises potentially inaccurate geolocation information for the transportation provider device used to produce the estimated time of arrival.

11. The computer-implemented method of claim 1, wherein the at least one source of uncertainty comprises out-of-date geolocation information for the transportation provider device used to produce the estimated time of arrival.

12. The computer-implemented method of claim 1, wherein the at least one source of uncertainty comprises potentially inaccurate route information for the transportation requestor device used to produce the estimated time of arrival.

13. The computer-implemented method of claim 1, wherein calculating, based on the at least one source of uncertainty, the statistical metric that reflects an uncertainty for the estimated time of arrival comprises:
identifying a set of sources of uncertainty;
calculating, for each source of uncertainty in the set of sources of uncertainty, at least one probability of at least one length of delay in estimated time of arrival; and
combining the set of probabilities calculated for the set of sources of uncertainty to arrive at the statistical metric that reflects the uncertainty.

14. A system comprising:
an identification module, stored in memory, that identifies at least one source of uncertainty in an estimated arrival time of a transportation provider device meeting a transportation requestor associated with a transportation requestor device;
a calculation module, stored in memory, that calculates, based on the at least one source of uncertainty, a statistical metric that reflects the uncertainty for the estimated time of arrival;
a matching module, stored in memory, that matches the transportation provider device with the transportation requestor device based at least in part on the statistical metric that reflects the uncertainty for the estimated time of arrival; and
at least one physical processor that executes the identification module, the calculation module, and the matching module.

15. The system of claim 14, wherein the calculation module calculates, based on the at least one source of uncertainty, the statistical metric that reflects the uncertainty for the estimated time of arrival by:
assigning a weight to each source of uncertainty in the at least source of uncertainty; and
calculating the statistical metric that reflects the uncertainty based at least in part on the weight of each source of uncertainty.

16. The system of claim 14, wherein the statistical metric that reflects the uncertainty comprises a probability distribution for the estimated time of arrival.

17. The system of claim 14, wherein the matching module matches the transportation provider device with the transportation requestor device based at least in part on the statistical metric that reflects the uncertainty for the estimated time of arrival by:
predicting, based on a characteristic of the at least one source of uncertainty, a decrease of the uncertainty within a predetermined time frame; and
delaying matching the transportation provider device with the transportation requestor device until the uncertainty decreases based at least in part on predicting that the uncertainty will decrease within the predetermined time frame.

18. The system of claim 14, wherein the matching module matches the transportation provider device with the transportation requestor device based at least in part on the statistical metric that reflects the uncertainty for the estimated time of arrival by determining that the uncertainty is within a predetermined threshold for acceptable uncertainty.

19. The system of claim 14, wherein the matching module matches the transportation provider device with the transportation requestor device based at least in part on the statistical metric that reflects the uncertainty for the estimated time of arrival by:
identifying a first transportation provider device with a first estimated time of arrival and a first uncertainty;
identifying a second transportation provider device with a second estimated time of arrival that is later than the first estimated time of arrival and a second uncertainty that is less than the first uncertainty; and
matching the second transportation provider device with the transportation requestor device based on the second uncertainty being less than the first uncertainty despite the second estimated time of arrival being later than the first estimated time of arrival.

20. A computer-readable medium comprising:
computer-readable instructions that, when executed by at least one processor of a computing device, cause the computing device to:
identify at least one source of uncertainty in an estimated arrival time of a transportation provider device meeting a transportation requestor associated with a transportation requestor device;
calculate, based on the at least one source of uncertainty, a statistical metric that reflects the uncertainty for the estimated time of arrival; and
match the transportation provider device with the transportation requestor device based at least in part on the statistical metric that reflects the uncertainty for the estimated time of arrival.
